(19) United States
(12) Patent Application Publication
(10) Pub. No.: US 2015/0256757 A1
(43) Pub. Date: Sep. 10, 2015

(54) PROVIDING A FRAME OF REFERENCE FOR IMAGES

(71) Applicant: North Main Group, Inc., Cedar City, UT (US)

(72) Inventors: Matthew M. Marriott, Enoch, UT (US); Kary W. Smith, Cedar City, UT (US)

(21) Appl. No.: 14/641,158

(22) Filed: Mar. 6, 2015

Related U.S. Application Data
(60) Provisional application No. 61/949,756, filed on Mar. 7, 2014.

(51) Int. Cl. H04N 5/232; H04N 7/18

(52) U.S. Cl. CPC H04N 5/23293; H04N 7/183; H04N 5/23216

(57) ABSTRACT

A method may include receiving a selection of an area of a body. The method may also include generating one or more gridlines in a viewfinder associated with a field of view of a camera based on the selected area. The one or more gridlines may be configured based on the area.

### FIELD

The embodiments discussed in the present disclosure are related to providing a frame of reference for images.

### BACKGROUND

Many industries depict “before” and “after” images of individuals to analyze the results of their products and services. For example, plastic surgeons often take “before” and “after” pictures to illustrate their work and accompanying changes that are made to their patients. However, the images are often captured from different perspectives or frames of reference such that an accurate comparison between the “before” and “after” images may be difficult to obtain.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

According to an aspect of an embodiment, a method may include receiving a selection of an area of a body. The method may also include generating one or more gridlines in a viewfinder associated with a field of view of a camera based on the selected area. The one or more gridlines may be configured based on the area.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates a block diagram of an example electronic device that may be configured to provide gridlines in a viewfinder used to capture an image;

FIG. 2 illustrates an example depiction of a touchscreen embodiment of a user interface, in which a user may select a type of grid to use based on an area of the body to be captured in an image;

FIG. 3 illustrates an example embodiment of a breast grid;

FIG. 4A illustrates an example embodiment of a face grid;

FIG. 4B illustrates use of the face grid of FIG. 4A with respect to a ¾-view of the face;

FIG. 4C illustrates use of the face grid of FIG. 4A with respect to a side-view of the face;

FIG. 5 illustrates an example embodiment of a torso grid; and

FIG. 6 is a flowchart of an example method of generating gridlines based on an area of a body.

### DESCRIPTION OF EMBODIMENTS

As described in further detail below, an electronic (e.g., a digital camera, a tablet computer, a laptop or desktop computer with a webcam (external or internal), a wireless phone, etc.) may be configured to include one or more gridlines in a viewfinder that represents a field of view of a camera that may be used to capture images. The gridlines may be configured (e.g., positioned, oriented, etc.) based on one or more areas of a body (e.g., a human body). The gridlines may provide a frame of reference when capturing an image of an area of the body (e.g., face, torso, chest, back, neck, skin, hair, stomach, buttocks, etc.) of a person. Accordingly, in some instances the same frame of reference may be used to capture images that may be used for “before” and “after” pictures, such as those used with respect to plastic surgery, weight loss, fitness, pregnancy, height, dermatology, etc. Multiple images captured with the same frame of reference may allow for a more accurate comparison of the same features that are included in the images.

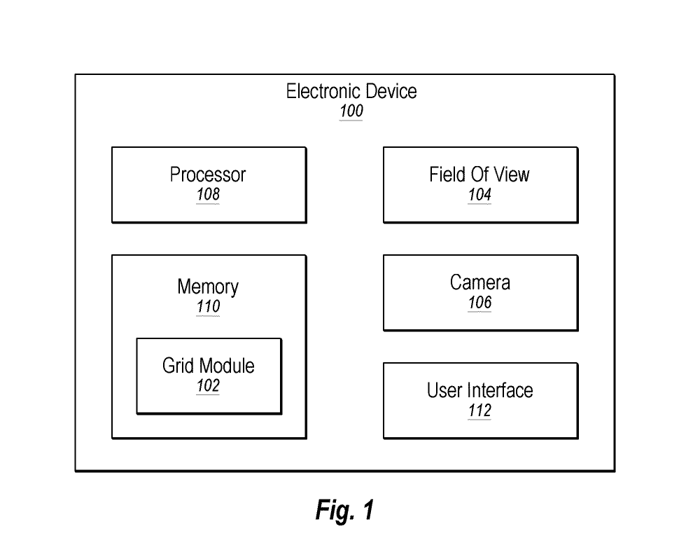

FIG. 1 illustrates a block diagram of an example electronic device 100 (the “device 100) that may be configured to provide gridlines in a viewfinder of a camera that may be used to capture an image, according to at least one embodiment described in the present disclosure. By way of example and not limitation, the device 100 may include a mobile phone, a tablet computer, a desktop computer, a laptop computer, a digital camera, a personal digital assistant (PDA), a smartphone, etc.

In some embodiments, the device 100 may include a camera 106. The camera 106 may include any camera known in the art that captures images and/or records digital video of any aspect ratio, size, and/or frame rate. The camera 106 may include a lens configured to focus light that may be received at an image sensor of the camera 106. The image sensor may be configured to sample and record a field of view of the lens. The image sensor, for example, may include a charge-coupled device (CCD) or a complementary metal-oxide semiconductor (CMOS) sensor. The camera 106 may provide raw or compressed image data, which may be stored within a memory 110 associated with the device 100. The image data provided by the camera 106 may include still image data (e.g., pictures) and/or a series of frames linked together in time as video data.

The device 100 may also include a viewfinder 104. The viewfinder 104 may include any suitable component that may display a field of view of the camera 106 that may be used by a user while capturing an image (e.g., taking a picture) with the camera 106. For example, in some embodiments, the viewfinder 104 may include a screen of the device 100 that may display the current field of view of the camera 106. In these or other embodiments, the viewfinder may include a more traditional viewfinder that a user may look into with one eye.

Although the device 100 is described as including both the viewfinder 104 and the camera 106, in some embodiments, the viewfinder 104 may be included with an electronic device separate from an electronic device that may include the camera 106. For example, in some embodiments the viewfinder 104 may include a screen of a smartphone or tablet computer that may be configured to receive and display the field of view of a camera of another device.

The device 100 may include a user interface 112. The user interface 112 may include any type of input/output device including buttons and/or a touchscreen. In some embodiments, the user interface 112 may include the same screen or display that may be used for the viewfinder 104. The user interface 112 may provide instructions to a controller 120 of the device 100 from the user and/or output data to the user. For example, in some embodiments, the user interface 112 may be used to select a type of gridline that may be based on an area of a body that a user may desire to capture in an image.

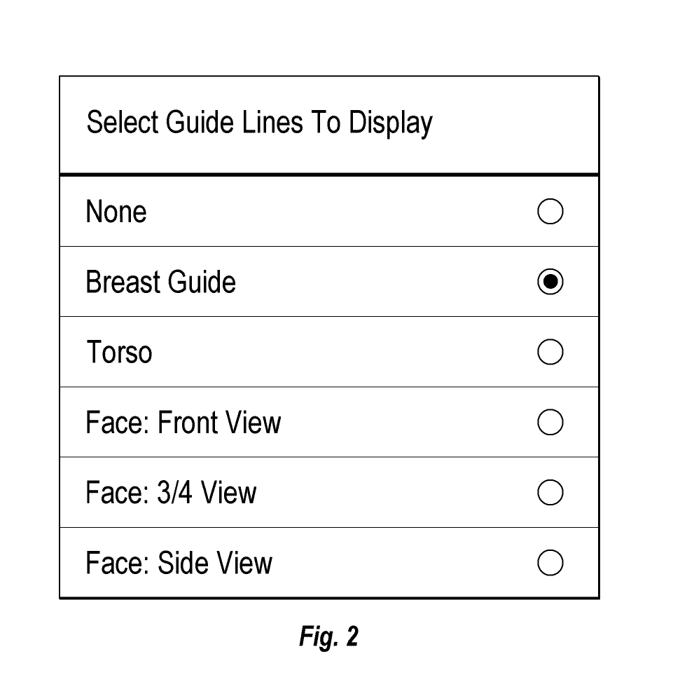

FIG. 2 illustrates an example depiction of a touchscreen embodiment of the user interface 112, in which the user may select a type of grid to use based on an area of the body to be captured in an image, according to at least one embodiment described in the present disclosure. In the illustrated embodiment, grid configurations associated with breasts (“breast grid”), a front view of a face (“front-face grid”), a ¾view of the face (“three-quarter face grid”), a side view of the face (“side-face grid”), and a torso (“torso grid”) may be selected, with the breast view being selected. Examples of the breast grid, front-face grid, three-quarter face grid, side-face grid, and torso grid are given below.

Returning to FIG. 1, the controller 120 may be configured to perform operations with respect to the device 100 and may include a processor 108, memory 110, and a grid module 102. The processor 108 may include any type of computing device that may act as a general-purpose or special-purpose computer. The processor 108 may include, for example, a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. In some embodiments, the processor 108 may interpret and/or execute program instructions and/or process data stored in a memory 110. Although illustrated as a single processor in FIG. 1, in some embodiments, the processor 108 may include any number of processors configured to perform, individually or collectively, any number of operations described in the present disclosure.

The memory 110 may include any suitable computer-readable media configured to retain program instructions and/or data for a period of time. By way of example, and not limitation, such computer-readable media may include tangible and/or non-transitory computer-readable storage media, including Random Access Memory (RAM), Read-Only Memory (ROM), Electrically Erasable Programmable Read-Only Memory (EEPROM), Compact Disk Read-Only Memory (CD-ROM) or other optical disk storage, magnetic disk storage or other magnetic storage devices, flash memory devices (e.g., solid state memory devices), a specific molecular sequence (e.g., DNA or RNA), or any other storage medium which may be used to carry or store program code in the form of computer-executable instructions or data structures and which may be accessed by the processors 150. Combinations of the above may also be included within the scope of computer-readable media. Computer-executable instructions may include, for example, instructions and data that cause a general purpose computer, special purpose computer, or special purpose processing device (e.g., the processor 108) to perform a certain function or group of functions.

In some embodiments, the memory 110 may include the grid module 102 stored thereon. The grid module 102 may be configured to generate gridlines in the viewfinder 104 that may be used as a frame of reference for capturing images with the camera 106. As mentioned above, the gridlines may be configured (e.g., oriented, and positioned) according to a target area of the body that may be the primary focus of an associated image. In these or other embodiments, the gridlines may be configured based on an associated procedure or change that may be associated with a particular area of the body. Further, the gridlines may be configured depending on a target viewing perspective of an area of the body. Additionally, the gridlines may be configured for the different areas of the body based on the specific features of the body that may be used as reference points for a particular frame of reference.

By way of example and not limitation, the gridlines may be configured based on focusing on the chest or breast area such that they may be configured as breast gridlines of a breast grid. The breast gridlines of the breast grid may be configured based on different features of the body that may be within an area surrounding the breasts that may be used as reference points. For example, the breast gridlines may be configured (e.g., positioned, oriented, sized, etc.) such that body parts such as the navel, the chin, the sternum, and/or the nipples may be used as reference points.

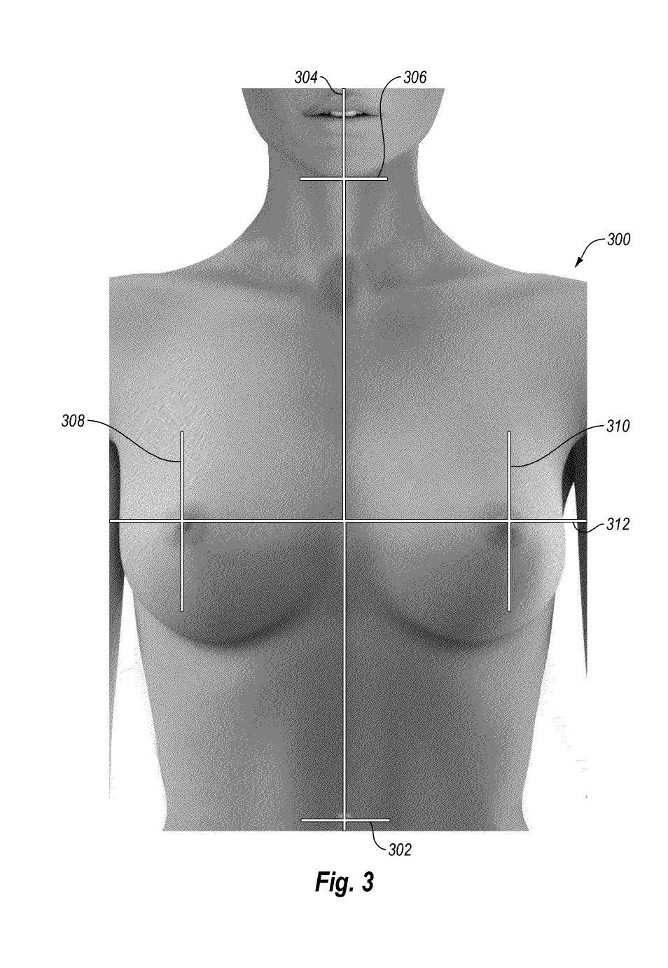

FIG. 3 illustrates an example embodiment of a breast grid 300, arranged according to at least one embodiment described in the present disclosure. The breast grid 300 may be configured for use with at least a front-view of the breast area and in the illustrated embodiment is depicted as being used as such. However, the breast grid 300 may also be used for side and/or ¾views of the breast area. The breast grid 300 may include a navel gridline 302, a chin gridline 306, a first nipple gridline 308, a second nipple gridline 310, a center-chest gridline 304, and a cross-chest gridline 312.

The navel gridline 302 may be a horizontal gridline and, in the illustrated example, may be configured to be aligned with (e.g., at, above, or below) the navel while capturing an image such that the navel and navel gridline 302 may be used as a reference points when capturing the image. The chin gridline 306 may also be a horizontal gridline and, in the illustrated example, may be configured (e.g., positioned, sized, oriented, etc.) such that it may be aligned with (e.g., at, above, or below) the chin while capturing the image such that the chin and chin gridline 306 may be used as reference points when capturing the image. Further, the center-chest gridline 304 may be a vertical gridline and in the illustrated example, may be configured (e.g., positioned, sized, oriented, etc.) such that it may be aligned with the center of the chest (e.g., the sternum) as illustrated when capturing the image such that the breast grid 300 may be centered with respect to the breast area of the subject whose image is being captured.

In these or other instances, the cross-chest gridline 312 may be a horizontal gridline and, in the illustrated embodiment, may be configured (e.g., positioned, sized, oriented, etc.) such that it may be aligned with the middle of the chest (e.g., such that it intersects the nipples as illustrated) such that the middle of the chest may be used as frame of reference when capturing the image. In other embodiments, the cross-chest gridline 312 may be configured (e.g., positioned, sized, oriented, etc.) such that it may be aligned with the armpits such that the armpits may be used as frame of reference when capturing the image.

Additionally or alternatively, the breast grid 300 may include a first cross-chest gridline that may be configured (e.g., positioned, sized, oriented, etc.) such that it may be aligned with a first area of the chest (e.g, the armpits) and a second cross-chest gridline that may be configured to be aligned with a second area of the chest (e.g., the nipples). Further, the nipple gridlines 308 and 310 may also be vertical gridlines configured to intersect with the cross-chest gridline 312. In the illustrated example, one or both of the nipple gridlines may be configured (e.g., positioned, sized, oriented, etc.) such that they may be aligned with the nipples when capturing the image.

Therefore, the breast grid 300 may be used to provide a consistent frame of reference when capturing images of the breast area such that changes to the breast area may be easily analyzed and observed by comparing two or more images of the breast area that may be captured using the breast grid 300. Although all the gridlines of the breast grid 300 are illustrated as being substantially aligned with their respective areas of the body, in some instances one or more of the gridlines of the breast grid 300 may not align as naturally with one or more of the body parts used as reference points.

Additionally, the breast grid 300 is merely one example of a breast grid that may be used for front view images of a breast area and is not limiting. Further, in some embodiments the breast grid 300 may be used for a side and/or ¾view of the breast area and in other embodiments, one or more other breast grids may be used for the side or ¾views of the breast area. Further, the use of body part terms to describe the different gridlines is not meant to limit which body parts the particular gridlines may be aligned with depending on the view used. Additionally, the alignment of certain gridlines with certain body parts is merely given as an example use of the gridlines to provide a consistent frame of reference, other uses and alignments of the gridlines with respect to other body parts may also be used. Further, a breast grid may include more or fewer gridlines than those specifically illustrated.

As another example, the gridlines may be configured based on focusing on the face area such that they may be configured as face gridlines of a face grid. In some embodiments, the face grid may also vary based on whether the target view of the face is from the side, the front, a ¾view, or any other type of view.

The face gridlines of the face grid may be configured based on different features of the face and surrounding area that may be used as reference points. For example, the face gridlines may be configured (e.g., positioned, oriented, sized, etc.) such that body parts such as the chin, the eyes, the mouth, the nose, the ears, eyebrows, etc., may be used as reference points.

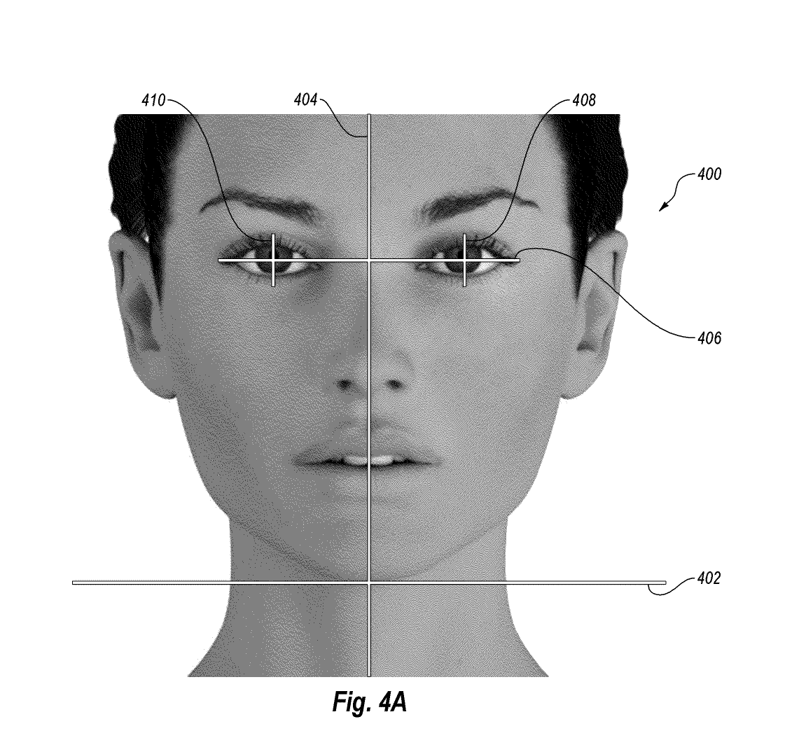

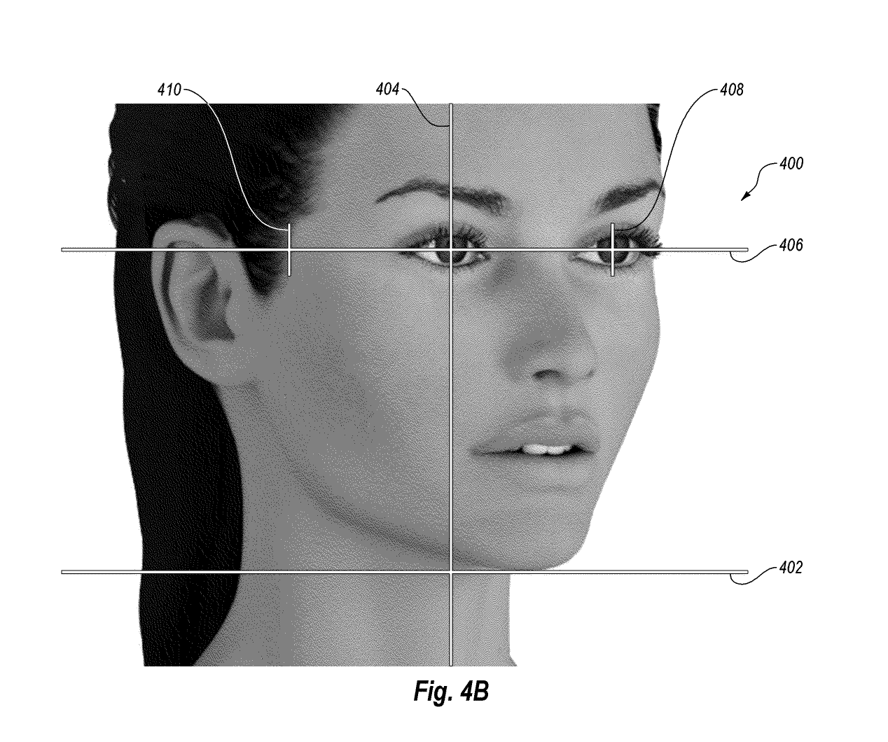

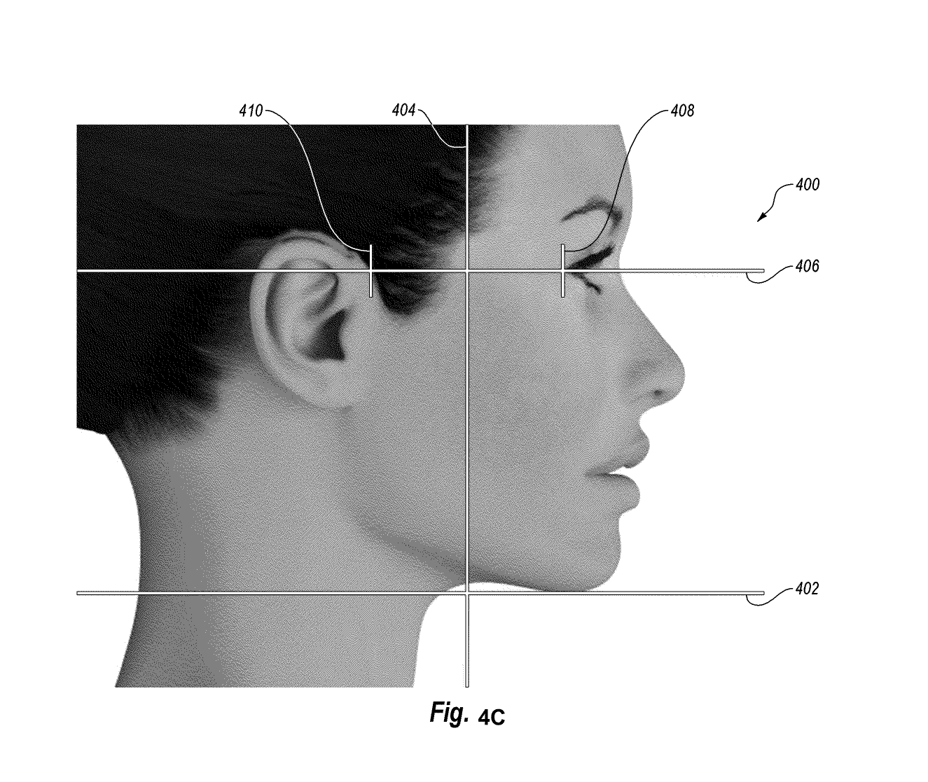

FIG. 4A illustrates an example embodiment of a face grid 400, arranged according to at least one embodiment described in the present disclosure. The face grid 400 may be configured for use with respect to a front-view, a side-view or a ¾view of the face. FIG. 4A illustrates use of the face grid 400 with respect to a front-view of the face. The face grid 400 may include a chin gridline 402, a center gridline 404, a cross-face gridline 406, a first cross-hair gridline 408, and a second cross-hair gridline 410.

The chin gridline 402 may be a horizontal gridline and in the illustrated embodiment may be configured (e.g., positioned, sized, oriented, etc.) such that it may be aligned with (e.g., at, above, or below) the chin while capturing an image such that the chin and chin gridline 402 may be used as a reference points when capturing the image. The center gridline 404 may be a vertical gridline and in the illustrated embodiments, may be configured (e.g., positioned, sized, oriented, etc.) such that it may be aligned with the center of the face (e.g., along the nose) as illustrated when capturing the image such that the face grid 400 may be centered with respect to the face of the subject whose image is being captured.

In these or other instances, the cross-face gridline 406 may be a horizontal gridline, and in the illustrated embodiment, may be configured (e.g., positioned, sized, oriented, etc.) such that it may be aligned with the eyes (e.g., such that it intersects the eyes as illustrated) such that the eyes may be used as frame of reference when capturing the image. Further, the cross-hair gridlines 408 and 410 may be vertical gridlines that may be configured to intersect the cross-face gridline 406 to create cross-hairs as illustrated. In the illustrated embodiment, the cross-hairs may be configured such that one or both cross-hairs may be aligned with the eyes when capturing the image.

FIG. 4B illustrates use of the face grid 400 with respect to a ¾-view of the face, according to at least one embodiment described in the present disclosure. In FIG. 4B, the chin gridline 402 may be aligned with (e.g., at, above, or below) the chin. The intersection of the center gridline 404 and the cross-face gridline 406 may be aligned with the subject's right pupil, and the cross-hair associated with the cross-hair gridline 408 and the cross-face gridline 406 may be aligned with the subject's left eye. FIG. 4C illustrates use of the face grid 400 with respect to a side-view of the face, according to at least one embodiment described in the present disclosure. In FIG. 4C, the chin gridline 402 may be aligned with (e.g., at, above, or below) the chin. Additionally, the cross-hair associated with the cross-hair gridline 408 and the cross-face gridline 406 may be aligned with the subject's eye as depicted.

Therefore, the face grid 400 may be used to provide a consistent frame of reference when capturing images of the face such that changes to the face may be easily analyzed and observed by comparing two or more images of the face that may be captured using the face grid 400. Although all the gridlines of the face grid 400 are illustrated as being substantially aligned with their respective areas of the body, in some instances one or more of the gridlines of the face grid 400 may not align as naturally with one or more of the body parts used as reference points.

Additionally, the face grid 400 is merely one example of a face grid that may be used for front view images of a face and is not limiting. Further, in some embodiments, one or more other face grids may be used for the side or ¾views of the face. Additionally, the alignment of certain gridlines with certain body parts is merely given as an example use of the gridlines to provide a consistent frame of reference, other uses and alignments of the gridlines with respect to other body parts may also be used. Similarly, the use of body part terms to describe the different gridlines is not meant to limit which body parts the particular gridlines may be aligned with depending on the view used. Further, a face grid may include more or fewer gridlines than those specifically illustrated.

As another example, the gridlines may be configured based on focusing on the torso area such that they may be configured as torso gridlines of a torso grid. The torso gridlines of the torso grid may be configured based on different features of the body that may be within an area around the torso that may be used as reference points. For example, the torso gridlines may be configured (e.g., positioned, oriented, etc.) such that body parts such as the navel, the chin, the armpits, the sternum, nipples, etc., may be used as reference points.

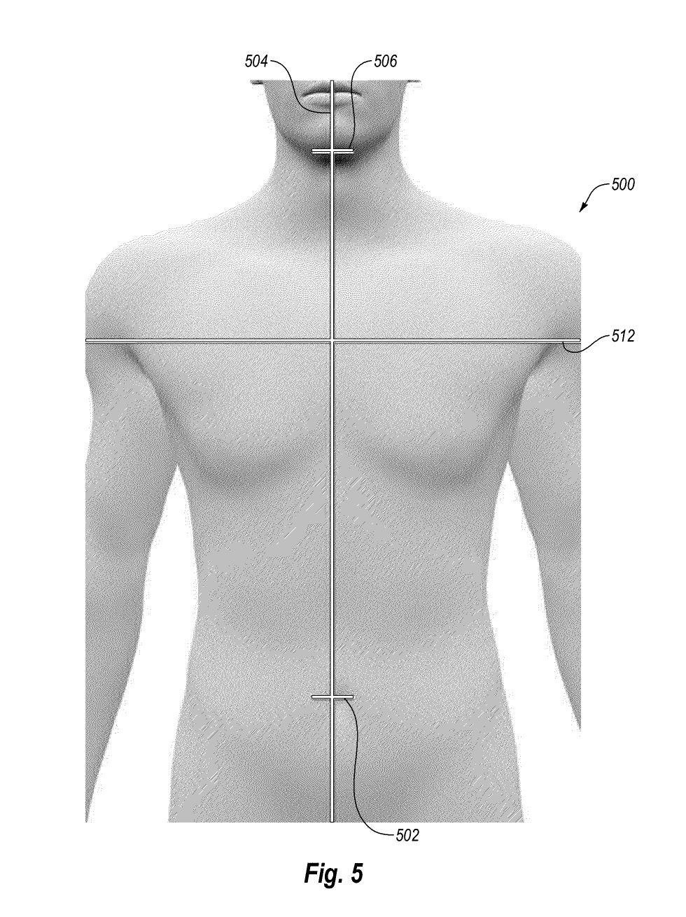

FIG. 5 illustrates an example embodiment of a torso grid 500, arranged according to at least one embodiment described in the present disclosure. The torso grid 500 may be configured for use with at least a front-view of the torso area and in the illustrated embodiment is depicted as being used as such. However, the torso grid 500 may also be used for side and/or ¾views of the torso area. The torso grid 500 may include a navel gridline 502, a chin gridline 506, a center-torso gridline 504, and a cross-torso gridline 512.

The navel gridline 502 may be a horizontal gridline and, in the illustrated example, may be configured (e.g., positioned, sized, oriented, etc.) such that it may be aligned with (e.g., at, above, or below) the navel while capturing an image such that the navel and navel gridline 502 may be used as a reference points when capturing the image. The chin gridline 506 may also be a horizontal gridline and, in the illustrated example, may be configured (e.g., positioned, sized, oriented, etc.) such that it may be aligned with (e.g., at, above, or below) the chin while capturing the image such that the chin and chin gridline 506 may be used as reference points when capturing the image.

Further, the center-torso gridline 504 may be a vertical gridline and in the illustrated example, may be configured (e.g., positioned, sized, oriented, etc.) such that it may be aligned with the center of the torso (e.g., the sternum) as illustrated when capturing the image such that the torso grid 500 may be centered with respect to the torso area of the subject whose image is being captured.

In these or other instances, the cross-torso gridline 512 may be a horizontal gridline and, in the illustrated embodiment, may be configured (e.g., positioned, sized, oriented, etc.) such that it may be aligned with the armpits (e.g., such that it intersects the top of the armpits as illustrated) such that the armpits may be used as frame of reference when capturing the image. In other embodiments, the cross-torso gridline 512 may be configured (e.g., positioned, sized, oriented, etc.) such that it may be aligned with the middle of the chest (e.g., such that it intersects the nipples of the subject) such that the middle of the chest may be used as frame of reference when capturing the image. Additionally or alternatively, the torso grid 500 may include a first cross-chest gridline that may be configured to be aligned with a first area of the chest (e.g, the armpits) and a second cross-chest gridline that may be configured to be aligned with a second area of the chest (e.g., the nipples).

Therefore, the torso grid 500 may be used to provide a consistent frame of reference when capturing images of the torso area such that changes to the torso area may be easily analyzed and observed by comparing two or more images taken of the torso area using the torso grid 500. Although all the gridlines of the torso grid 500 are illustrated as being substantially aligned with their respective areas of the body, in some instances one or more of the gridlines of the torso grid 500 may not align as naturally with one or more of the body features used as reference points.

Additionally, the torso grid 500 is merely one example of a torso grid that may be used for front view images of a torso area and is not limiting. Further, in some embodiments the torso grid 500 may be used for a side and/or ¾view of the torso area and in other embodiments, one or more other torso grids may be used for the side or ¾views of the breast area. Further, the use of body part terms to describe the different gridlines is not meant to limit which body parts the particular gridlines may be aligned with depending on the view used. Additionally, the alignment of certain gridlines with certain body parts is merely given as an example use of the gridlines to provide a consistent frame of reference, other uses and alignments of the gridlines with respect to other body parts may also be used.

Further, a torso grid may include more or fewer gridlines than those specifically illustrated. For example, in some embodiments, the torso grid 500 may include nipple gridlines analogous to the nipple gridlines 308 and 310 of FIG. 3.

The above examples of the breast grid 300, the face grid 400, and the torso grid 500 are merely examples of gridlines that may be generated based on areas of the body, views of the areas etc. Other grids and associated gridlines may also be generated for other areas of the body, views, and procedures without departing from the scope of the present disclosure. For example, grids may be generated for the lower torso area, buttocks area, thigh area, etc., to illustrate changes in those areas such as weight loss, liposuction changes, tummy tuck changes, fat melting procedure changes, body lift changes, cellulite changes, pregnancy changes (e.g., stages of pregnancy), etc. Further, other grids may be generated to illustrate changes in the neck, skin (e.g., marks and scars, tattoos, moles, warts, acne, cancer, rash, wrinkles, aging, etc.), head (e.g., hairline, hair transplant, baldness treatments, etc.), other hair treatments (e.g., laser hair treatments), mouth (e.g., jaw and teeth), ears, back and spine, x-ray and bone structure changes, and whole body changes (e.g., weight gain and loss, muscle gain and loss, height changes, etc.). Grids may also be generated to illustrate changes in movement by different body parts (e.g., knees, elbows, ankles, fingers, feet etc.) to illustrate changes in range of motion, flexibility, movement, rotation, etc.

Further, in some embodiments, the gridlines of a particular grid may be static and in other embodiments, the gridlines may be moved. For example, in some embodiments, the grid module 102 of FIG. 1 may be configured to allow the user to manually move the gridlines via the user interface 112. In these or other embodiments, the grid module 102 may be configured to auto-align one or more of the gridlines to body features of the area (e.g., facial features, breast features, etc.) using techniques similar to those in facial recognition.

Additionally or alternatively, in some embodiments, the grid module 102 may be configured to remove gridlines or add gridlines in response to a user input. In these or other embodiments, the grid module 102 may be configured to change a size, shape, width, orientation, etc. in response to one or more user inputs.

In these or other embodiments, the grid module 102 may be configured to store particular gridline configurations such that they may be reused at a later time. For example, the positions of one or more gridlines may be moved to capture an image of a particular body area of a particular subject. The grid module 102 may be configured to store the positions (e.g., in response to a user command) such that when another image is taken of the body area of the particular subject at a later time, the gridline positions used for the previous image may be used again. In some embodiments, the particular gridline configurations may be stored as metadata

Further, the grid module 102 may be configured to perform operations related to creating, embedding, linking, etc., information with metadata of an associated image file of an image that may be captured by the camera 106. For example, the grid module 102 may include information in the metadata that is related to a particular configuration of the gridlines when the image was captured.

Additionally, in some embodiments, the grid module 102 may be configured such that the gridlines are included with and shown on the images that are captured as well as being depicted in the viewfinder 104. Therefore, previously captured images with the gridlines included therein may be superimposed in the viewfinder such that the gridlines from the previously captured image may be aligned with the gridlines on the viewfinder.

Accordingly, in some embodiments, grids and associated gridlines may be generated and superimposed within the viewfinder 104. The gridlines may be based on an area of the body to provide a frame of reference when capturing images of the area of the body with the camera. As such, a consistent frame of reference may be used for different images to help facilitate analysis and identification of changes in the area of the body of interest.

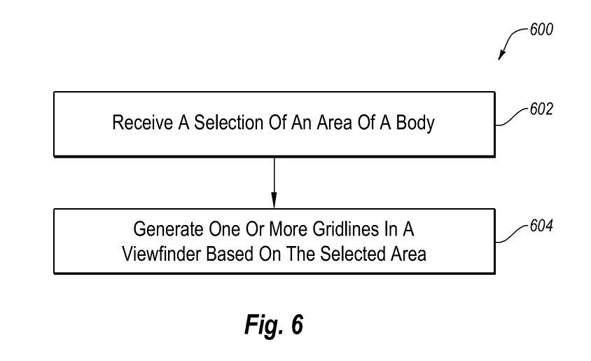

FIG. 6 is a flowchart of an example method 600 of generating gridlines based on an area of a body, according to at least one embodiment described in the present disclosure. The method 600 may be performed by any suitable system, apparatus, or device. For example, the grid module 102 of FIG. 1 may be configured to direct the electronic device 100 of FIG. 1 to perform one or more of the operations associated with the method 600. Although illustrated with discrete blocks, the steps and operations associated with one or more of the blocks of the method 600 may be divided into additional blocks, combined into fewer blocks, or eliminated, depending on the implementation.

The method 600 may begin at block 602, where a selection of an area of a body may be received. In some embodiments, the selection may be received via a user interface. The area of the body may include any applicable area of the body that may be of interest with respect to capturing an image of a subject with respect to the selected area. For example, the area of the body may include a face, a torso area, a breast area, a buttocks area, a stomach area, etc.

At block 604, one or more gridlines may be generated in a viewfinder associated with a field of view of a camera based on the selected area. The gridlines may be configured based on the area in some embodiments. Additionally or alternatively, the gridlines may be configured based on one or more body features associated with the area. The configuration of the gridlines may include the positions, sizes, orientations, number of gridlines, etc.

For example, when the area includes a breast area or a torso area, the gridlines may be configured based on one or more of the following body features: navel, chin, nipples, armpits, and sternum. In some embodiments, when the area includes a breast area or a torso area, the gridlines may form a breast grid or a torso grid, respectively, such as the breast grid 300 of FIG. 3 and the torso grid 500 of FIG. 5, respectively.

As another example, when the area includes a face, the gridlines may be configured based on one or more of the following body features: eyes, nose, chin, mouth, ears, and eyebrows. In some embodiments, when the selected area includes a face, the gridlines may form a face grid such as the face grid 400 of FIGS. 4A, 4B, and 4C.

Accordingly, the method 600 may be used to generate gridlines based on a selected area of a body. Modifications, additions, or omissions may be made to the method 600 without departing from the scope of the present disclosure. For example, the operations of method 600 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the disclosed embodiments.

For example, in some embodiments, the method 600 may include operations associated with further receiving a selection of a particular perspective (e.g., a front perspective, a side perspective, a ¾profile perspective) associated with the area.

Further, in some embodiments, the method 600 may include one or more operations in which gridlines may be configured, added, removed, etc., within the viewfinder based on a user input. In these or other embodiments, the method 600 may include one or more operations associated with automatically adjusting a position of a particular gridline in the viewfinder such that the particular gridline aligns with a particular body feature associated with the area.

Further, the method 600 may include operations related to performing other functions with respect to the gridlines and or captured images such as aligning and cropping, alignment of images for comparison; dynamic measurements and display. Further, the method 600 may include, in some embodiments, operations related to creating, embedding, linking, etc., gridline configuration information with metadata of an associated image file of an image that may be captured by a camera (e.g., the camera 106).

In these or other embodiments, the method 600 may include one or more operations associated with storing particular gridline alignments and/or positions such that they may be reused at a later time. Additionally, in some embodiments, the method 600 may include one or more operations associated with including the gridlines on the images that are captured as well as being shown in the viewfinder. Additionally or alternatively, the method 600 may include operations related to superimposing previously captured images with the gridlines included therein in the viewfinder such that the gridlines from the previously captured image may be aligned with the gridlines on the viewfinder.

As described above, the embodiments described in the present disclosure may include the use of a special-purpose or general-purpose computer (e.g., the processor 108 of FIG. 1) including various computer hardware or software modules, as discussed in greater detail below. The special purpose or general purpose computer may be configured to execute computer-executable instructions stored on computer-readable media (e.g., the memory 110 of FIG. 1).

As used in the present disclosure, the terms “module” or “component” may refer to specific hardware implementations configured to perform the operations of the module or component and/or software objects or software routines that may be stored on and/or executed by general purpose hardware (e.g., computer-readable media, processing devices, etc.) of the computing system. In some embodiments, the different components, modules, engines, and services described may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated. In this description, a “computing entity” may be any computing system as previously defined in the present disclosure, or any module or combination of modulates running on a computing system.

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present inventions have been described in detail, it should be understood that the various changes, substitutions, and alterations could be made hereto without departing from the spirit and scope of the present disclosure.

What is claimed is:

1. A method comprising:
receiving a selection of an area of a body; and
generating one or more gridlines in a viewfinder associated with a field of view of a camera based on the selected area, the one or more gridlines being configured based on the area.

2. The method of claim 1, wherein the one or more gridlines are configured based on one or more body features associated with the area.

3. The method of claim 1, wherein the area includes a face.

4. The method of claim 3, wherein the one or more gridlines are configured based on one or more of the following body features and their relative locations with respect to each other: eyes, nose, chin, mouth, ears, and eyebrows.

5. The method of claim 1, wherein the area includes a breast area.

6. The method of claim 5, wherein the one or more gridlines are configured based on one or more of the following body features: navel, chin, nipples, armpits and sternum.

7. The method of claim 1, wherein the area includes a torso area.

8. The method of claim 7, wherein the one or more gridlines are configured based on one or more of the following body features: navel, chin, nipples, armpits, and sternum.

9. The method of claim 1, further comprising adjusting a position of one or more of the gridlines in the viewfinder in response to a user input.

10. The method of claim 1, further comprising automatically adjusting a position of a gridline in the viewfinder such that the gridline aligns with a body feature associated with the area.

11. Computer-readable storage media including computer-executable instructions configured to cause a system to perform operations, the operations comprising:
receiving a selection of an area of a body; and
generating one or more gridlines in a viewfinder associated with a field of view of a camera based on the selected area, the one or more gridlines being configured based on the area.

12. The computer-readable storage media of claim 11, wherein the one or more gridlines are configured based on one or more body features associated with the area.

13. The computer-readable storage media of claim 11, wherein the area includes a face.

14. The computer-readable storage media of claim 13, wherein the one or more gridlines are configured based on one or more of the following body features: eyes, nose, chin, mouth, ears, and eyebrows.

15. The computer-readable storage media of claim 11, wherein the area includes a breast area.

16. The computer-readable storage media of claim 15, wherein the one or more gridlines are configured based on one or more of the following body features: navel, chin, nipples, armpits and sternum.

17. The computer-readable storage media of claim 11, wherein the area includes a torso area.

18. The computer-readable storage media of claim 17, wherein the one or more gridlines are configured based on one or more of the following body features: navel, chin, nipples, armpits, and sternum.

19. The computer-readable storage media of claim 11, wherein the operations further comprise adjusting a position of one or more of the gridlines in the viewfinder in response to a user input.

20. The computer-readable storage media of claim 11, wherein the operations further comprise automatically adjusting a position of a gridline in the viewfinder such that the gridline aligns with a body feature associated with the area.
